(19) United States
(12) Patent Application Publication
(10) Pub. No.: US 2006/0140342 A1
(43) Pub. Date: Jun. 29, 2006

(54) Apparatus for measuring the momentum transfer spectrum of elastically scattered X-ray quanta

(75) Inventor: Geoffrey Harding, Hamburg (DE)

Correspondence Address: DONALD R. KINSLEY;MARKS, O'NEILL, O'BRIEN & COMPANY, P.C., 913 N. MARKET ST., SUITE 800, WILMINGTON, DE, 19801, US

(73) Assignee: GE Security Germany GmbH

(21) Appl. No.: 11/301,742

(22) Filed: Dec. 13, 2005

(30) Foreign Application Priority Data
Dec. 26, 2004 (DE) 102004060611.0

(51) Int. Cl. G01N 23/04

(52) U.S. Cl. 378/57

(57) ABSTRACT

Apparatus for measuring momentum transfer spectrum of elastically scattered X-ray quanta includes an anode having a focus extended in the Y-direction which emits X-radiation in the X-direction. The apparatus also includes a primary collimator extending in the Y-direction and allowing X-ray quanta to pass through which are aimed at an individual isocentre, wherein the isocentre is the originating point of a cartesian coordinates system, an examination area, a scatter collimator system extending annularly about the Z-direction and arranged between said examination area and the isocentre. Said collimator system passes through scattered radiation from an object to be examined wherein the radiation is emitted at a fixed scatter angle Θ. The apparatus further includes a detector located in the Y-Z plane, distanced from a Z-axis and has a curved shape. Wherein a X-component of a scatter voxel of the object is clearly imaged onto Z-components of said detector.

### CROSS REFERENCE TO RELATED APPLICATIONS

This Application claims the benefit of priority of Federal Republic of Germany Patent Application No.: 102004060611.0, filed Dec. 16, 2004, which is hereby incorporated by reference in its entirety.

### BACKGROUND OF THE INVENTION

This invention relates generally to apparatus for measuring the momentum transfer spectrum of elastically scattered X-ray quanta.

An apparatus for the examination of items of luggage is described in EP 1 241 470 B1. Such an apparatus has a focus extended in the Y-direction which emits X-radiation in the X-direction. Through a primary collimator extending in the Y-direction only X-ray quanta which are aimed at an individual isocentre are passed through into an examination area behind. The isocentre forms the originating point of a Cartesian coordinates system. A disk-shaped inverted fan beam is thus formed. A scatter collimator system which is developed annularly about the Z-direction is arranged between the isocentre and the examination area. The result is that only scattered radiation from an object located in the examination area is passed through which starts from a scatter voxel at a fixed preset scatter angle. A detector which extends along the Z-axis is arranged in the Y-Z plane. Depth information regarding the scatter voxel, i.e. its X-coordinate, is thereby imaged onto a parallel of the Y-axis in the Y-Z plane. By means of such an arrangement a rapid analysis of an item of luggage can be achieved, with only a one-dimensional movement of the item of luggage along the Z-direction on a conveyor belt. The scanning speed is, however, limited by the angle-dependent sensitivity of the detector elements.

### BRIEF DESCRIPTION OF THE INVENTION

Apparatus is provided for measuring momentum transfer spectrum of elastically scattered X-ray quanta includes an anode having a focus extended in the Y-direction which emits X-radiation in the X-direction. The apparatus also includes a primary collimator extending in the Y-direction and allowing X-ray quanta to pass through which are aimed at an individual isocentre, wherein the isocentre is the originating point of a Cartesian coordinates system, an examination area, a scatter collimator system extending annularly about the Z-direction and arranged between said examination area and the isocentre. Said collimator system passes through scattered radiation from an object to be examined wherein the radiation is emitted at a fixed scatter angle E. The apparatus further includes a detector located in the Y-Z plane, distanced from a Z-axis and has a curved shape. Wherein a X-component of a scatter voxel of the object is clearly imaged onto Z-components of said detector.

### BRIEF DESCRIPTION OF THE DRAWINGS

FIG. 1 is a schematic view of an apparatus according to one embodiment of the invention that does not include a scatter collimator.

FIG. 2 is one embodiment of the invention including a detector element in the Y-Z plane.

### DETAILED DESCRIPTION OF THE INVENTION

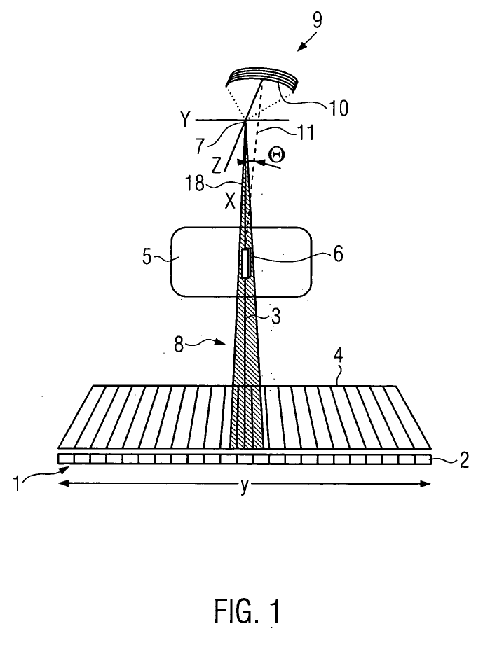

An embodiment of an arrangement according to the invention is schematically represented in FIG. 1. A section along the X-Y plane is shown. The apparatus according to the invention is represented in perspective at the top, i.e. in the region of the Y-Z plane.

The arrangement according to the invention has an anode 1 extending in a Y-direction which has a series of horizontally ranged discrete focus points 2 which move along the anode 1 when fired upon by an electron beam. A number of focus points 2 are provided in an area (for reasons of clarity, only a small number of focus points 2 are represented). The X-ray quanta emanating from each individual focus point 2 are bound by a primary collimator 4 which has a fan shape, such that an inverted fan beam 8 of X-ray quanta results as primary beam 3. This inverted fan beam 8 runs in the X-Y plane and converges on a single isocentre 7 which simultaneously forms the coordinates source of a Cartesian coordinates system. Primary beam 3 strikes an object 5 in the object area. In one embodiment, the apparatus is a luggage examination apparatus and object 5 is a suitcase. Object 5 then lies on a conveyor belt (not shown) which can be moved along the Z-axis. As long as object 5 is not moved along the Z-axis by the conveyor belt, inverted fan beam 8 passes through object 5 along a thin slice in the X-Y plane. This slice is changed by a one-dimensional movement of the conveyor belt in the Z-direction, so that a complete scanning of the object can be accomplished by moving the conveyor belt.

The momentarily scanned thin slice consists of a number of scatter voxels 6, each of which has an X-coordinate (varying depth along the X-direction) and a Y-coordinate (varying lateral arrangement with regard to the X-axis). At each individual scatter voxel 6, primary beam 3 of X-ray quanta is scattered. Of the X-ray quanta scattered at this scatter voxel 6, the coherently scattered X-ray quanta are of particular interest within the framework of the present invention. These quanta are imaged into the Y-Z plane by means of a scatter collimator system, such as that described in EP 1 241 470 B1, so that a direct allocation to the depth of scatter voxel 6 takes place from its position along the X-direction in object 5. Accordingly, in the exemplary embodiment, only X-ray quanta from the scatter collimator system scattered at scatter voxel 6 which have a preset constant scatter angle Θ are passed through as scatter beam 11. Passed through scatter beam 11 is represented by a dotted line in FIG. 1.

On the basis of the scatter collimator system developed annularly about the Z-direction, not only scatter quanta in the X-Z plane pass through, but also those which have a coordinate other than Y=0. These quanta that have a coordinate other than Y=0 are covered by a two-dimensional detector 9 arranged in the Y-Z plane. Although the detector apparatus described in EP 1 241 470 B1 extends only along the Z-axis, the individual detector elements 10 according to the exemplary embodiment of the invention extend in Y-direction. More scatter quanta of scatter beam 11 emanating from scatter voxel 6 which are passed through by the scatter collimator system and belong to the fixed scatter angle Θ can thereby be detected by detector 9. The more scatter quanta that are covered, the less time is utilized to record the momentum transfer spectrum of the elastically scattered X-ray quanta.

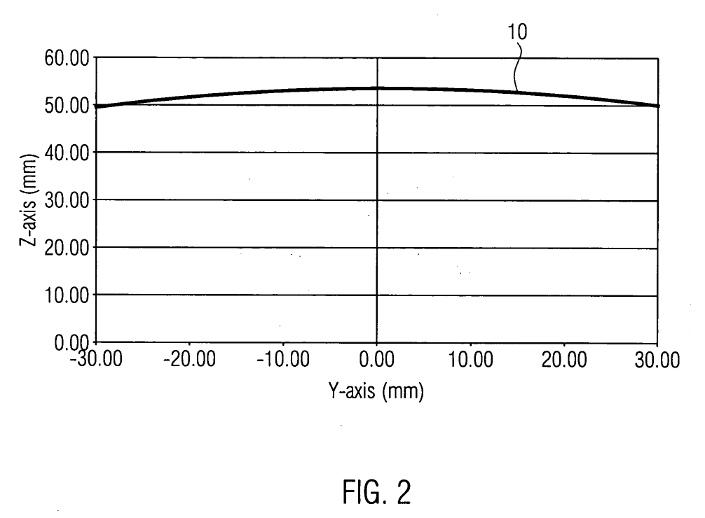

By extending detector 9 in the Y-direction, detector sensitivity is extended over a larger solid angle. However, in the case of a linear extension of detector elements 10 parallel to the Y-axis, a blurring effect of the diffraction profile occurs. The degree of the blurring effect is dependent on the scatter angle Θ. Accordingly, the measured scatter angle differs more markedly from the set scatter angle Θ with regard to the X-Z plane as the distance between detector element 10 and the Z-axis increases. To eliminate this blurring effect, detector elements 10 are provided having a curved shape. Their geometric shape is represented in FIG. 2 and their lengths are shown in millimetres. Each detector element 10 is symmetrical to the Z-axis and has the shape of a section cut from an ellipse according to the formula a₁²Z²+a₂²Y²=a₃², where a₁, a₂ and a₃ are constants which depend on the geometry of the scatter collimator and an object area. In the embodiment shown in FIG. 2, a detector element 10 extends a length of approximately 60 mm in Y-direction. The distance of the represented detector element 10 from the Y-axis in the Z-direction varies between less than about 50 mm at its outer ends and about 53 mm in the centre of the Z-axis. The extension of detector element 10 in the Y-direction is thus larger by a factor of approximately 6 than that of known detector elements. Detector sensitivity is thereby increased by approximately the same factor, i.e., compared to known detector sensitivity without the disadvantage of a reduced resolution due to the blurring effect of the diffraction profile.

Detectors 9 according to one embodiment of the invention have an elliptical shape and are fabricated from germanium, or another semiconductor material, by a standard lithography process. In an alternative embodiment, to obtain an even better signal-to-noise ratio, a second set of detector elements 10 are arranged in mirror symmetry to the Y-axis.

In the exemplary embodiment, the detector elements lie on an ellipse with the principal axis along the Y-axis. Because of the imaging geometry the imaging of the elastically scattered X-ray quanta emanating from a scatter voxel takes place on a curved line in the Y-Z plane which extends along an ellipse. Thus the sensitivity of the detector over a large solid angle is achieved.

In addition, the detector elements have a shape according to the equation a₁²Z²+a₂²Y²=a₃², where a₁, a₂ und a₃ are constants which depend on the geometry of the scatter collimator and on the area to be examined of the object. An optimum detector sensitivity over a large solid angle without the above-described blurring effects occurring is achieved by the three constants matched to the respective detector geometry.

Further, the detector elements are between approximately 40 mm and approximately 70 mm long in Y-direction and/or between approximately 0.25 mm and approximately 2 mm wide in Z-direction. In the exemplary embodiment, the detector elements are approximately 60 mm long in the Y-direction and 0.5 mm wide in the Z-direction. A marked increase in detector sensitivity which lies in the range of a factor of 10 compared to known detectors is thereby achieved.

In addition, the detector elements are symmetrical to the Z-axis. Due to the geometric design of the apparatus, the detector elements have a shape to achieve as high as possible a detector sensitivity both to the left and also to the right of the Z-axis. The detector elements are, in one embodiment, fabricated from germanium by means of a lithography process.

In a further embodiment, a second set of detector elements is arranged symmetrical to the Y-axis. An even better signal-to-noise ratio is thereby obtained.

Accordingly, detector sensitivity is increased over a much greater solid angle without the spectral resolution of the diffraction profile being reduced. A high direct-current load of the X-ray source is achieved through the use of anode 1 with a large number of focus points 2. Additionally, a mechanical shift—including of detector 9—is avoided and a reduction in partial volume artefacts with reduced voxel volume is obtained. Furthermore, because of the simple correlation of the sets of data from two detectors 9 arranged symmetrically to the Y-axis (second detector 9 is omitted for reasons of clarity) a high scanning speed of objects 5 is possible. Scan times below six seconds can be achieved for normal objects.

While the invention has been described in terms of various specific embodiments, those skilled in the art will recognize that the invention can be practiced with modification within the spirit and scope of the claims.

What is claimed is:

1. Apparatus for measuring momentum transfer spectrum of elastically scattered X-ray quanta comprising:
an anode having a focus extended in the Y-direction which emits X-radiation in the X-direction;
a primary collimator extending in the Y-direction and allowing X-ray quanta to pass through which are aimed at an individual isocentre, wherein the isocentre is the originating point of a cartesian coordinates system;
an examination area;
a scatter collimator system extending annularly about the Z-direction and arranged between said examination area and the isocentre, said collimator system passes through scattered radiation from an object to be examined, the radiation emitted at a fixed scatter angle Θ; and
a detector located in the Y-Z plane and distanced from a Z-axis, each said detector element has a curved shape, wherein a X-component of a scatter voxel of the object is clearly imaged onto Z-components of said detector.

2. Apparatus according to claim 1 wherein said detector elements lie on an ellipse having a principal axis along the Y-axis.

3. Apparatus according to claim 1 wherein said detector elements have a shape according to the equation a₁²Z²+a₂²Y²=a₃², wherein a₁, a₂ and a₃ are constants which depend on the geometry of said scatter collimator and of said area to be examined of the object.

4. Apparatus according to claim 1 wherein said detector element between approximately 40 and approximately 70 mm long in Y-direction.

5. Apparatus according to claim 1 wherein said detector element approximately 60 mm long in Y-direction.

6. Apparatus according to claim 1 wherein said detector elements are configured to be symmetrical to the Z-axis.

7. Apparatus according to claim 1 wherein said detector elements are between approximately 0.25 mm and approximately 2 mm wide in the Z-direction.

8. Apparatus according to claim 1 wherein said detector elements are approximately 0.5 mm wide in the Z-direction.

9. Apparatus according to claim 1 wherein said detector elements fabricated from germanium.

10. Apparatus according to claim 1 wherein said detector elements fabricated using a lithography process.

11. Apparatus according to claim 1 further comprising a second set of detector elements arranged symmetrically to the Y-axis.
